(19) United States
(12) Patent Application Publication
(10) Pub. No.: US 2013/0004252 A1
(43) Pub. Date: Jan. 3, 2013

(54) Clamp Auxiliary Member and Cutting Tool with the Clamp Auxiliary Member

(75) Inventor: Shiro Yoshioka, Iwaki-shi (JP)

(73) Assignee: Tungaloy Corporation, Iwaki-shi (JP)

(21) Appl. No.: 13/608,503

(22) Filed: Sep. 10, 2012

Related U.S. Application Data
(63) Continuation-in-part of application No. PCT/JP2010/054058, filed on Mar. 10, 2010.

(51) Int. Cl. B23B 27/16; B23C 5/22

(52) U.S. Cl. 407/103; 407/110

(57) ABSTRACT

A clamp auxiliary member is low in manufacturing costs has a simple structure, is applicable to a small-diameter tool, and facilitates replacement of a cutting insert in a cutting tool. The cutting insert is mounted to a tool body by means of the clamp auxiliary member, which is provided with an engagement portion for engaging a fastening screw. The clamp auxiliary member is formed in a ring shape and has one or more slits notching a part thereof. The clamp auxiliary member, and is flexibly deformed at the time the force is applied to an inner peripheral face upper portion thereof from the head portion of the fastening screw to expand the outer diameter. A cutting tool may be provided with such a clamp auxiliary member.

### RELATED APPLICATIONS

This is a Continuation-in-part of International Application No. PCT/JP2010/054058, filed on Mar. 10, 2010 and published as WO 2011/111198 A1. The contents of the aforementioned application are incorporated by reference in their entirety.

### BACKGROUND OF THE INVENTION

1. Field of the Invention

The present invention relates to an elastically deformable clamp auxiliary member used upon mounting a cutting insert to a tool body and a cutting tool equipped with the elastically deformable clamp auxiliary member, and particularly to an elastically deformable clamp auxiliary member used for mounting a cutting insert in a cutting tool of a screw-on method in which the cutting insert is fixed to a tool body by a screw and a cutting tool equipped with the clamp auxiliary member.

2. Description of the Related Art

As to a clamping method of a cutting insert used in a cutting tool, there is known a screw-on method in which a fastening screw is threaded into a screw hole formed in the bottom of a mounting seat in a tool body through a mounting hole provided in the cutting insert, thereby fixing the cutting insert to the tool body. According to this screw-on method, since the cutting insert can be mounted to the tool body by a single screw, the cutting tool of the screw-on method can be inexpensively manufactured in a simple structure. Further, since the tool management in this method is easy to perform, and particularly this method is compact in design, in many cases this method is adopted in an indexable cutting tool in which a space for mounting the cutting insert is limited.

In contrast, in the indexable cutting tool adopting such a screw-on method, the fastening screw has to be completely removed from the screw hole in the mounting seat at replacement of the cutting insert, bringing in a complicated operation and inconvenience. Therefore in a milling cutter having many teeth or the like, long hours are required for replacement of the cutting insert, causing deterioration in work efficiency. Further, since a small fastening screw is used in a case of a tool having a small diameter, at the time an operator removes the fastening screw from the tool body, the operator quite often drops the screw, which is lost. In the indexable cutting tool, since removal of the fastening screw is frequently performed for replacement of the cutting insert, an improvement on operability and work efficiency is greatly demanded.

For solving this problem, Japanese Patent Laid-Open No. 2008-23643 proposes an indexable cutting tool which can perform replacement of the cutting insert without complete removal of the fastening screw from the tool body. In Japanese Patent Laid-Open No. 2008-23643, a clamp auxiliary member is used upon mounting the cutting insert to the tool body.

The cutting insert can be replaced without removing the fastening screw by using the technology described in Japanese Patent Laid-Open No. 2008-23643. Therefore it is possible to shorten replacement hours of the cutting insert, and there is no possibility that the fastening screw is lost due to dropping thereof at replacement.

However, the clamp auxiliary member used in Japanese Patent Laid-Open No. 2008-23643 is structured in a complicated shape and requires high manufacturing costs of components. In addition, since it is difficult to ensure the space, the clamp auxiliary member is difficult to be mounted to an end mill having a small diameter, and can be applied only to a large-diameter tool.

Therefore an object of the present invention is to provide a clamp auxiliary member and a cutting tool provided with the clamp auxiliary member, which are low in manufacturing costs in a simple structure, applicable to a small-diameter tool, and excellent in operability at replacement of a cutting insert.

### SUMMARY OF THE INVENTION

For solving the above problem, an elastically deformable clamp auxiliary member and a cutting tool provided with the elastically deformable clamp auxiliary member according to the present invention adopt the following means.

A clamp auxiliary member includes a ring-shaped main body which, when a cutting insert provided with a mounting hole formed therein is clamped to a mounting seat in a tool body by a bolt inserted into the mounting hole, expands in a diameter between the cutting insert and the bolt to press the cutting insert from an inside thereof, thereby assisting the clamping of the cutting insert by the bolt, the clamp auxiliary member comprising a first engagement portion engaged to a large-diameter portion formed in the bolt and expanding the main body in a diameter by a relative movement to the bolt, a second engagement portion capable of being engaged to a retaining portion provided in the bolt when the main body does not expand in a diameter, and a third engagement portion applying a pressing force to an inner peripheral wall of the mounting hole, wherein when the bolt is threaded into a screw hole provided in the mounting seat in a state where the second engagement portion is engaged to the retaining portion, the clamp auxiliary member makes contact with the mounting seat, which restricts the movement to cause a relative movement thereof to the bolt, the first engagement portion is subjected to a force from the large-diameter portion to be expanded in a diameter, the engagement of the second engagement portion is released simultaneously with the diameter expanding of the first engagement portion, the third engagement portion presses the inner peripheral wall of the mounting hole to clamp the cutting insert to the mounting seat, and when the bolt threaded into the screw hole is loosened, the second engagement portion is returned back to the retaining portion by the recovery force.

The third engagement portion may be formed to be capable of allowing at least one of eccentricity between a center axis line of the cutting insert and a center axis line of the screw hole in the mounting seat, and an inclination of the center axis line of the screw hole to a center axis line of the mounting hole in the cutting insert fixed to the mounting seat.

The third engagement portion may further be formed as a curved surface curved in a convex shape to the inner peripheral wall of the mounting hole in the cutting insert.

A cutting tool comprises a cutting insert provided with a mounting hole, a tool body provided with a mounting seat, a bolt for clamping the cutting insert to the mounting seat of the tool body, and a clamp auxiliary member provided with a ring-shaped main body which is, when the cutting insert is clamped to the mounting seat in the tool body by the bolt, interposed between the cutting insert and the bolt to flexibly expand in a diameter therebetween to assist the clamping of the cutting insert by the bolt, wherein the bolt comprises a retaining portion for retaining the clamp auxiliary member in a state where the clamp auxiliary member is not expanded in a diameter, and a large-diameter portion for expanding the clamp auxiliary member in a diameter, and the clamp auxiliary member comprises a first engagement portion engaged to the large-diameter portion formed in the bolt and expanding the main body in a diameter by a relative movement to the bolt, a second engagement portion capable of being engaged to the retaining portion in the bolt, and a third engagement portion capable of making contact with an inner peripheral wall of the mounting hole in the cutting insert at the time of being expanded in a diameter by the large-diameter portion, wherein when the bolt is tightened, the clamp auxiliary member moves together with the bolt in a state where the second engagement portion is engaged to the retaining portion, the clamp auxiliary member makes contact with the mounting seat, which restricts the movement to cause a relative movement thereof to the bolt, thereby the engagement of the second engagement portion is released and the first engagement portion is subjected to a force from the large-diameter portion to be expanded in a diameter to clamp the cutting insert to the mounting seat, and when the bolt tightened into the mounting hole in the cutting insert is loosened, the second engagement portion is returned back to the retaining portion by the recovery force.

The clamp auxiliary member in the present invention comprises a first engagement portion engaged to a large-diameter portion formed in the bolt and expanding the main body in a diameter by a relative movement to the bolt, a second engagement portion capable of being engaged to a retaining portion provided in the bolt, and a third engagement portion applying a pressing force to an inner peripheral wall of the mounting hole, wherein when the bolt is threaded into a screw hole provided in the mounting seat in a state where the second engagement portion is engaged to the retaining portion, the clamp auxiliary member makes contact with the mounting seat, which restricts the movement to cause a relative movement thereof to the bolt, the first engagement portion is subjected to a force from the large-diameter portion to be expanded in a diameter, the engagement of the second engagement portion is released simultaneously with the diameter expanding of the first engagement portion, the third engagement portion presses the inner peripheral wall of the mounting hole to clamp the cutting insert to the mounting seat, and when the bolt threaded into the screw hole is loosened, the second engagement portion is returned back to the retaining portion by the recovery force. This configuration makes it possible to realize the clamp auxiliary member which is low in manufacturing costs in a simple structure, applicable to a small-diameter tool, and excellent in operability at replacement of the cutting insert.

In addition, the cutting tool in the present invention comprises a cutting insert provided with a mounting hole, a tool body provided with a mounting seat, a bolt for clamping the cutting insert to the mounting seat of the tool body, and a clamp auxiliary member provided with a ring-shaped main body which is, when the cutting insert is clamped to the mounting seat in the tool body by the bolt, interposed between the cutting insert and the bolt to flexibly expand in a diameter therebetween to assist the clamping of the cutting insert by the bolt, wherein the bolt comprises a retaining portion for retaining the clamp auxiliary member and a large-diameter portion for expanding the clamp auxiliary member in a diameter, the clamp auxiliary member comprises a first engagement portion engaged to the large-diameter portion formed in the bolt and expanding the main body in a diameter by a relative movement to the bolt, a second engagement portion capable of being engaged to the retaining portion in the bolt, and a third engagement portion capable of making contact with an inner peripheral wall of the mounting hole in the cutting insert, wherein when the bolt is tightened, the clamp auxiliary member moves together with the bolt in a state where the second engagement portion is engaged to the retaining portion, the clamp auxiliary member makes contact with the mounting seat, which restricts the movement to cause a relative movement thereof to the bolt, thereby the engagement of the second engagement portion is released and the first engagement portion is subjected to a force from the large-diameter portion to be expanded in diameter to clamp the cutting insert to the mounting seat, and when the bolt tightened into the mounting hole in the cutting insert is loosened, the second engagement portion is returned back to the retaining portion by the recovery force. This configuration makes it possible to realize the cutting tool which is low in manufacturing costs in a simple structure, applicable to a small-diameter tool, and excellent in operability at replacement of the cutting insert.

Further features of the present invention will become apparent from the following description of exemplary embodiments (with reference to the attached drawings).

### BRIEF DESCRIPTION OF THE DRAWINGS

FIG. 1A is a perspective view showing a clamp auxiliary member according to a first embodiment;

FIG. 1B is a plan view showing the clamp auxiliary member according to the first embodiment;

FIG. 1C is a side view showing the clamp auxiliary member according to the first embodiment;

FIG. 2A is a diagram showing a cutting insert and the clamp auxiliary member according to the present embodiment;

FIG. 2B is a diagram showing the cutting insert and the clamp auxiliary member according to the present embodiment;

FIG. 3A is a diagram showing a tool body and the cutting insert mounted to the tool body;

FIG. 3B is a diagram showing the tool body and the cutting insert mounted to the tool body;

FIG. 3C is a diagram showing the tool body and the cutting insert mounted to the tool body;

FIG. 4A is a diagram showing a tool body in which a position of a screw hole for mounting the cutting insert is shifted to a wall side, and the cutting insert mounted to the tool body;

FIG. 4B is a diagram showing the tool body in which the position of the screw hole for mounting the cutting insert is shifted to the wall side, and the cutting insert mounted to the tool body;

FIG. 4C is a diagram showing the tool body in which the position of the screw hole for mounting the cutting insert is shifted to the wall side, and the cutting insert mounted to the tool body;

FIG. 4D is a plan view in FIG. 4C;

FIG. 5A is a diagram showing a modification of the clamp auxiliary member according to the first embodiment;

FIG. 5B is a diagram showing a modification of the clamp auxiliary member according to the first embodiment;

FIG. 6A is a diagram showing a clamp auxiliary member according to a second embodiment;

FIG. 6B is a diagram showing the clamp auxiliary member according to the second embodiment;

FIG. 6C is a diagram showing the clamp auxiliary member according to the second embodiment;

FIG. 7A is a diagram showing a clamp auxiliary member according to a third embodiment;

FIG. 7B is a diagram showing the clamp auxiliary member according to the third embodiment;

FIG. 7C is a diagram showing the clamp auxiliary member according to the third embodiment;

FIG. 8A is a diagram showing a clamp auxiliary member according to a fourth embodiment;

FIG. 8B is a diagram showing the clamp auxiliary member according to the fourth embodiment; and

FIG. 8C is a diagram showing the clamp auxiliary member according to the fourth embodiment.

### DESCRIPTION OF THE EMBODIMENTS

### First Embodiment

Hereinafter, a first embodiment in the present invention will be described with reference to the drawings.

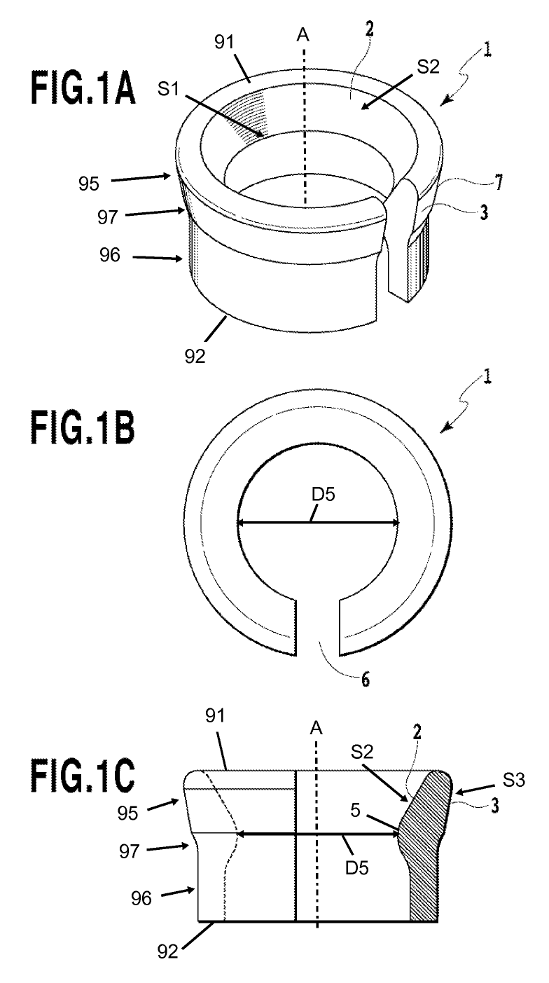

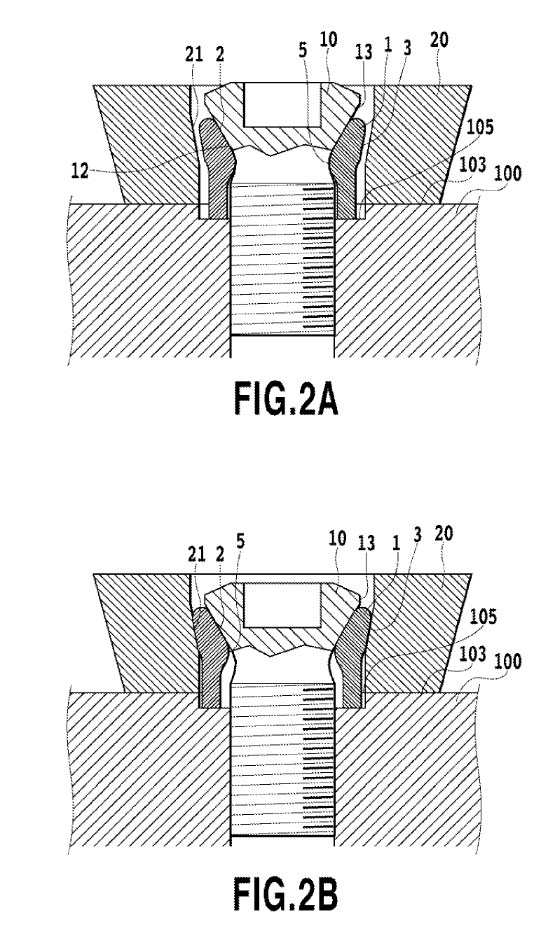

FIG. 1A to FIG. 1C are diagrams each showing an elastically deformable clamp auxiliary member 1 according to the present embodiment, wherein FIG. 1A is a perspective view, FIG. 1B is a plan view, and FIG. 1C is a side view. FIG. 2A and FIG. 2B are diagrams each showing a cutting insert 20 and a clamp auxiliary member 1 according to the present embodiment, wherein FIG. 2A shows a state before tightening a bolt (hereinafter, called also a fastening screw) 10, and FIG. 2B shows a state where the cutting insert 20 is fixed by completely tightening the fastening screw 10. The clamp auxiliary member 1 according to the present embodiment is formed in a substantially cylindrical shape and is provided with a ring-shaped main body 7, a part of which is notched. The main body 7 has a central member axis A and extends in an axial direction between a top surface 91 and a bottom surface 92. The main body 7 of the clamp auxiliary member 1 has an upper portion 95 proximate the top surface 91, a lower portion 96 proximate the bottom surface 92 and a central portion 97 in-between. The upper portion 95 has an outer diameter that varies in the axial direction and is larger than the diameter of the lower portion 96.

An inner peripheral face upper portion S2 of the clamp auxiliary member 1 is provided with a first engagement portion (hereinafter, called simply an inclined inner face) 2 having an inner inclination substantially equal to that of a head portion outer peripheral face of the fastening screw 10.

In addition, an outer peripheral face upper portion S3 of the clamp auxiliary member 1 is provided with a third engagement portion (hereinafter, called simply an inclined outer face) 3 having an outer inclination substantially equal to that of an inclined face 21 of an inner peripheral face of a mounting hole in the cutting insert 20. Further, a notch portion (hereinafter, called also a through slit portion) 6 of the clamp auxiliary member 1 forms part of a slit having a height equal to that of the clamp auxiliary member 1 in such a manner as to completely notch a part of the ring-shaped clamp auxiliary member 1.

In view of prevention of attrition to be generated by the rubbing of the clamp auxiliary member 1 with the mounting hole of the cutting insert 20 for each time of replacement of the cutting insert 20, the clamp auxiliary member 1 is formed of a steel material having a thermal treatment hardness of 35HRC or more, for example, carbon steel, alloy steel, stainless steel, dies steel, titanium alloy or the like.

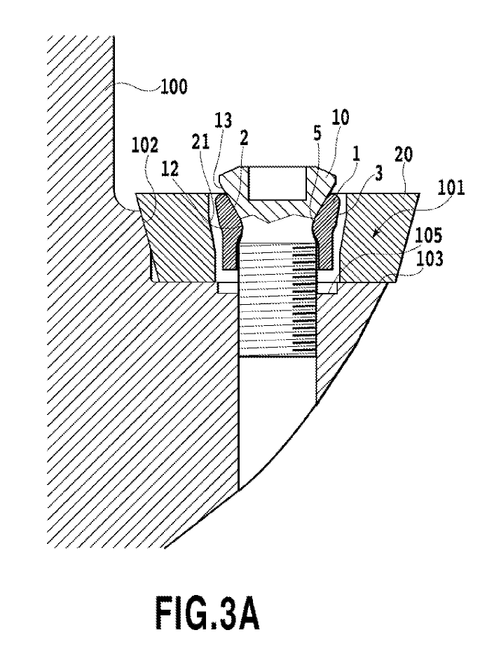

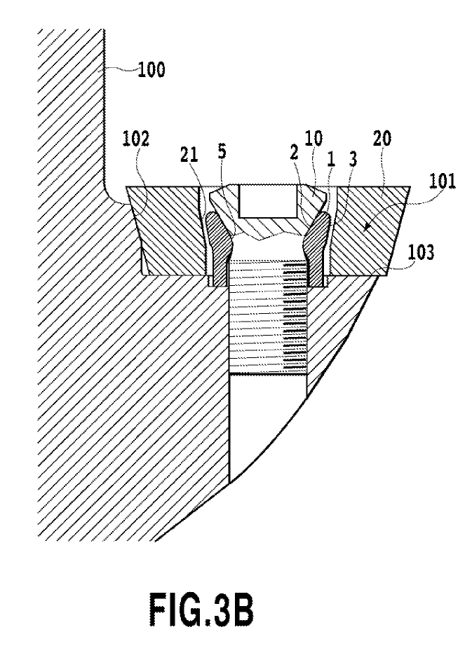

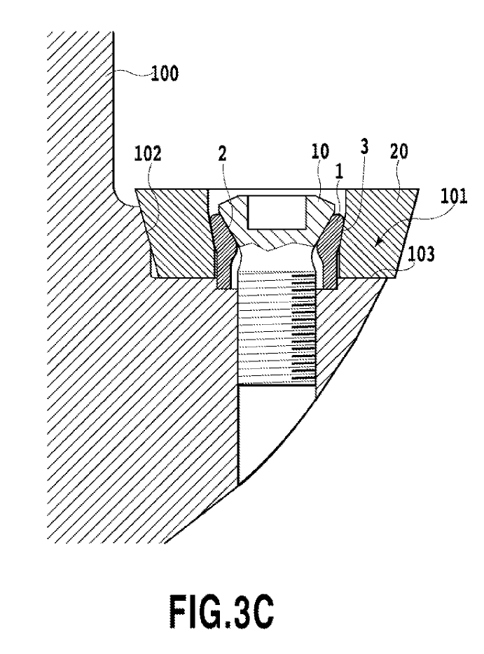

FIG. 3A to FIG. 3C are diagrams each showing a tool body 100 and the cutting insert 20 mounted in tool body 100, wherein FIG. 3A shows a state where the fastening screw 10 is inserted into the mounting hole of the cutting insert 20, FIG. 3B shows a state where the fastening screw 10 is tightened up halfway, and FIG. 3C shows a state where the fastening screw 10 is completely tightened up.

The clamp auxiliary member 1 is used upon installing the cutting insert 20 in an indexable cutting tool, and, as shown in FIG. 2A and FIG. 2B, the clamp auxiliary member 1 is inserted into the mounting hole of the cutting insert 20 when the fastening screw 10 is inserted. By threading the fastening screw 10 into a screw hole provided in a mounting seat face 103 of the tool body 100 for tightening, the clamp auxiliary member 1 retained by the fastening screw 10 makes contact with a counter bore 105 provided in the mounting seat face 103 of the tool body 100. In addition, when the fastening screw 10 is further tightened up, the clamp auxiliary member 1 is released from a retaining portion of the fastening screw 10, and receives forces in both the screw forward direction and the radius expanding direction from an inclined face of an outer peripheral face of a large-diameter portion (hereinafter, called also a head portion) 13 of the fastening screw 10 to expand a through slit portion 6 of the clamp auxiliary member 1, and at the same time, expands in a diameter with elastic deformation to make the inclined inner face 2 be in contact with the inclined face of the outer peripheral face of the head portion 13 in the fastening screw 10 and to make the inclined outer face 3 be in contact with the inclined face 21 of the inner peripheral face of the mounting hole in the cutting insert 20, thus fixing the cutting insert 20 to a mounting seat 101 of the tool body 100.

In addition, by loosening the fastening screw 10, the force applied to the clamp auxiliary member 1 by the head 13 of the fastening screw 10 is gradually weakened, and the clamp auxiliary member 1 which had been expanded in a diameter by the elastic deformation now contracts in a diameter by a recovery force to be returned back to a state of being retained by the retaining portion of the fastening screw 10. When the elastic deformation of the clamp auxiliary member 1 is back to an original state, an outer peripheral diameter of the clamp auxiliary member 1 is made smaller than an inner peripheral diameter of the mounting hole in the cutting insert 20. Since a head portion outer peripheral diameter of the fastening screw 10 is smaller than the inner peripheral diameter of the mounting hole in the cutting insert 20, when the elastic deformation of the clamp auxiliary member 1 is back to the original state, removal of the cutting insert 20 is made possible, and the cutting insert 20 fixed to the tool body 100 can be released without completely pulling the fastening screw 10 out of the tool body 100.

It can be seen from the foregoing, that the upper portion 95 of clamp auxiliary member 1 is configured to expand in a radially outward direction, in response to a force applied along the central member axis A in the direction of the bottom surface 92, when such force impacts the inner peripheral face upper portion S2.

As described above, when the elastic deformation of the clamp auxiliary member 1 is back to the original state by loosening the fastening screw 10, a retaining portion (hereinafter, called also a small-diameter portion or a neck) 12 provided in a lower part of the head portion 13 in the fastening screw 10 is engaged to a second engagement portion (hereinafter, called also a fitting portion) 5 of the clamp auxiliary member 1, the fitting portion 5 located on an inner peripheral face S1 of the main body 7 where inner peripheral face S1 has a minimum dimension D5. Therefore the clamp auxiliary member 1 does not drop down out of the fastening screw 10 even if the fastening screw 10 is completely pulled out of the tool body 100, and can be pulled out at the same time with the fastening screw 10. In this manner, even in a case of completely pulling the fastening screw 10 out of the tool body 100 at the time of removal of the cutting insert 20, it is possible to prevent the clamp auxiliary member 1 from being lost. This is because the clamp auxiliary member 1 is constructed to be loosely retainable, via its fitting portion 5, on the neck 12 of a corresponding fastening screw 10.

As a result, the clamp auxiliary member 1 according to the present embodiment is used, thereby making it possible to perform replacement of the cutting insert 20 simply and easily without completely removing the fastening screw 10 out of the screw hole of the tool body 100. In a milling cutter having many teeth also, the replacement or the like of the cutting insert 20 can be performed in a short time, largely improving operability and work efficiency at the time of removal of the cutting insert 20. Also at the time of indexing, removal or replacement of the cutting insert 20, since a screwed state between the fastening screw 10 and the tool body is ensured, an operator does not drop or lose the fastening screw. In addition, even if the fastening screw 10 is completely removed from the tool body 100, since the clamp auxiliary member 1 remains engaged to the fastening screw 10, it is possible to prevent the clamp auxiliary member 1 from dropping and being lost in a single unit.

In addition, since the clamp auxiliary member 1 according to the present embodiment is not provided with a threaded portion or the like, work thereupon is easy and manufacturing costs thereof can be suppressed. It can be applied not only to the large-diameter tool but also to a small-diameter end mill and the like.

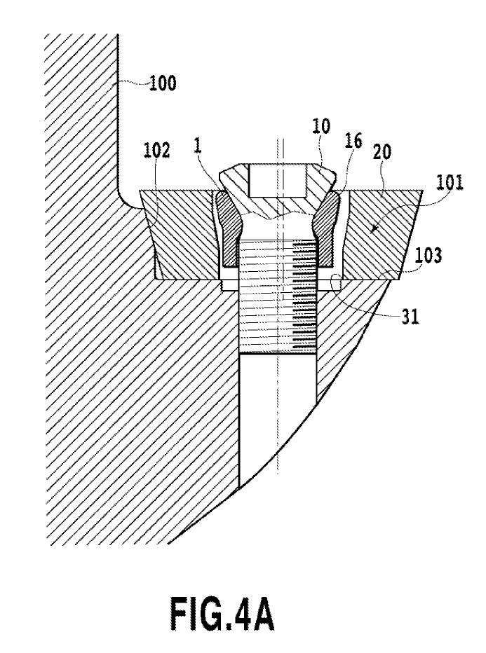

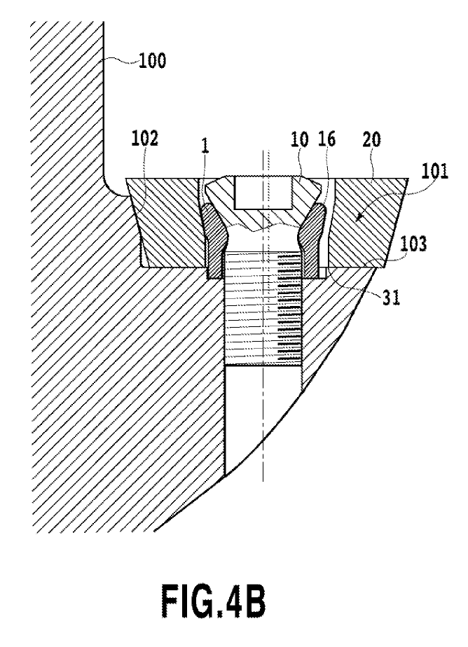

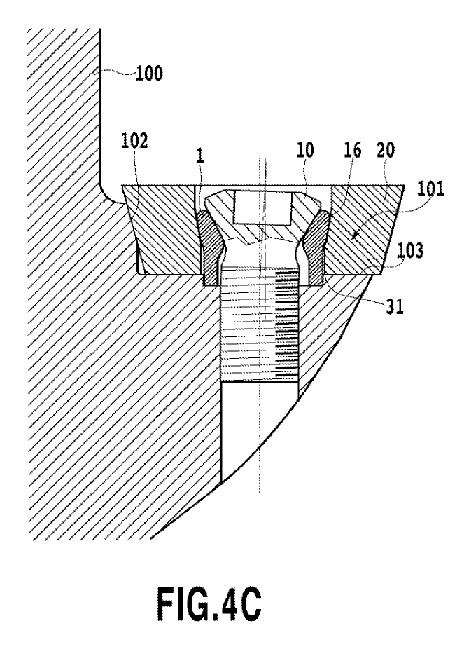

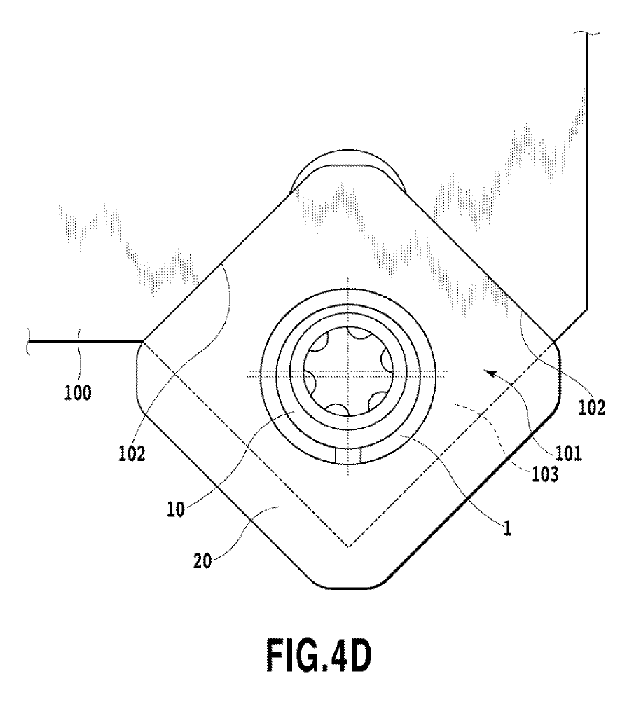

FIG. 4A to FIG. 4D are diagrams each showing the tool body 100 in which a position of a screw hole for mounting the cutting insert 20 is shifted to a wall side, and the cutting insert 20 is mounted to the mounting seat 101 of the tool body 100. FIG. 4A shows a state where the fastening screw 10 is inserted into the mounting hole of the cutting insert 20, and FIG. 4B shows a state where the fastening screw 10 is tightened halfway, FIG. 4C shows a state where the fastening screw 10 is completely tightened up, and FIG. 4D is a plane view in the state in FIG. 4C.

It is possible to use the clamp auxiliary member 1 according to the present embodiment to be eccentric (e.g., offset relative) to the mounting hole of the cutting insert 20.

In general, in the indexable cutting tool, for mounting the cutting insert 20, the mounting is performed in such a manner as to press the cutting insert 20 to a wall face 102 of the mounting seat in the tool body 100. Therefore to facilitate pressing the cutting insert 20 to the wall face 102 of the mounting seat in the tool body 100, a position of the screw hole of the mounting seat face 103 in the tool body 100 is shifted closer to a side of the wall face 102 of the mounting seat.

The clamp auxiliary member 1 according to the present embodiment can be used even if the position of the screw hole of the mounting seat face 103 in the tool body 100 is shifted to the side of the wall surface 102 of the mounting seat 101. That is, even if the screw hole of the mounting seat face 103 is an eccentric screw hole, since an outer diameter of the clamp auxiliary member 1 is smaller than the mounting hole of the cutting insert 20, a clearance between the inner peripheral face of the mounting hole in the cutting insert 20 and the outer peripheral face of the clamp auxiliary member 1 exists and the clamp auxiliary member 1 remains engaged to the fastening screw 10 even when the fastening screw 10 is loosened. Therefore the fastening screw 10 and the clamp auxiliary member 1 move simultaneously. In consequence, the cutting insert 20 can be removed without removing the fastening screw 10 from the tool body 100.

When mounting the cutting insert 20, the outer peripheral face of the clamp auxiliary member 1 on the wall face 102 side of the mounting seat 101 first makes contact with the inner peripheral face of the mounting hole in the cutting insert 20 upon initial tightening of the fastening screw 10, as seen in FIG. 4B. Afterwards, upon further tightening up the fastening screw 10, the clamp auxiliary member 1 flexibly deforms to expand in a diameter in a direction opposite to the wall face 102 side of the mounting seat. Finally, as shown in FIG. 4C and FIG. 4D, the outer peripheral face of the clamp auxiliary member 1 on the side opposite to the wall face 102 side of the mounting seat makes contact with the inner peripheral face of the mounting hole in the cutting insert 20 to mount the cutting insert 20 to the screw hole shifted to the side of the wall face 102 of the mounting seat, thereby fixing the cutting insert 20 to the mounting seat 101 of the tool body 100. This generates a force for the clamp auxiliary member 1 to press the cutting insert 20 closer to the wall face 102 of the mounting seat, making it possible to inevitably press the cutting insert 20 to the wall face 102 of the mounting seat in the tool body 100.

In this manner, the clamp auxiliary member 1 according to the present embodiment can be mounted even in a state where a center axis of the mounting hole in the cutting insert 20 is shifted relative to a center axis of the fastening screw 10, i.e., when the center axis of the fastening screw is laterally offset from the center axis of the mounting hole of the seated cutting insert 20.

It should be noted that a fitting section 16 in the outer peripheral side in the uppermost portion of the clamp auxiliary member 1 is preferably chamfered. Along with it, a fitting section 31 in the bottom side of the mounting hole 30 in the cutting insert 20 fitted into the fitting section 16 is also preferably chamfered. In this way, when the fitting section 16 and the fitting section 31 are chamfered, the clamp auxiliary member 1 can be smoothly pressed into the mounting hole 30.

The inner peripheral face upper portion S2 of the clamp auxiliary member 1 is preferably chamfered to be tailored to the configuration of the head portion of the fastening screw 10. For example, in a case where the head portion of fastening screw 10 has a tapered shape, the inner peripheral face in the upper portion S2 of the clamp auxiliary member 1 is preferably also chamfered in a tapered shape (inverted conical shape) having an angle substantially equal to the tapered angle of the head portion seat face of the fastening screw 10. When the chamfer tailored to the configuration of the head portion seat face of the fastening screw 10 is formed in the fitting section of the clamp auxiliary member 1 in this manner, in a case where the fastening screw 10 is threaded into the screw portion of the tool body 100, contact faces between the inner peripheral face upper portion S2 of the clamp auxiliary member 1 and the head portion of the fastening screw 10 form a state of an entire surface contact, creating excellent tightness. In addition, therefore the attrition in the contact faces between the inner peripheral face upper portion S2 of the clamp auxiliary member 1 and the head portion of the fastening screw 10 can be suppressed. There is no possibility that a groove is generated in the contact face to break the head portion of the fastening screw 10.

### (Modification)

Hereinafter, a modification in the present embodiment will be explained. In the present embodiment, the inclined outer face 3 of the clamp auxiliary member 1 makes surface contact with the inclined face 21 of the inner peripheral face of the mounting hole in the cutting insert 20, but the present embodiment is not limited thereto. That is, the inclined outer face 3 of the clamp auxiliary member 1 may be formed in a three-dimensional curved shape to make line contact with the inclined face 21 of the inner peripheral face of the mounting hole in the cutting insert 20.

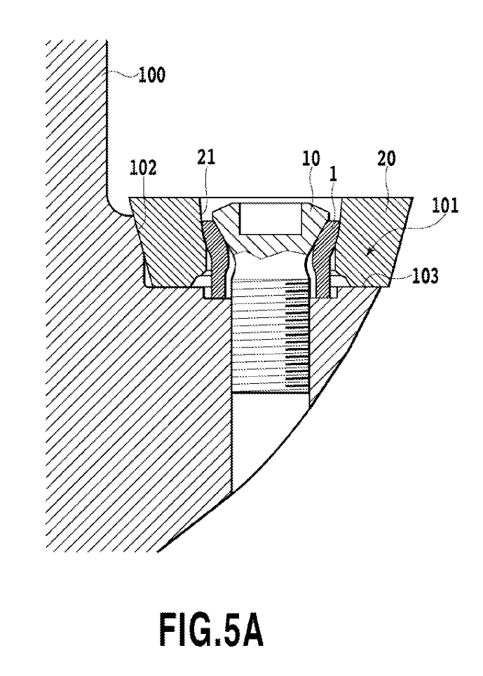

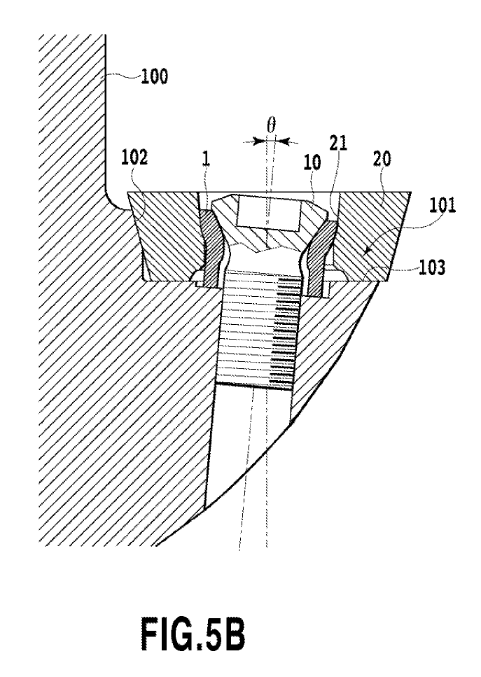

FIG. 5A and FIG. 5B are diagrams each showing a modification of the clamp auxiliary member according to the present embodiment, wherein FIG. 5A shows a state where a screw hole is provided to be perpendicular to the mounting seat face 103 of the tool body 100 for mounting the cutting insert 20, and FIG. 5B shows a state where the screw hole is provided to be inclined at an angle 8 to a perpendicular line to the mounting seat face 103 of the tool body 100 for mounting the cutting insert 20. In the clamp auxiliary member 1 according to the modification in the present embodiment, an outer peripheral face thereof making contact with the inner peripheral face of the mounting hole in the cutting insert 20 is formed in a three-dimensional curved surface, and the outer periphery of the clamp auxiliary member 1 makes line contact with the inclined face 21 of the inner peripheral face of the mounting hole in the cutting insert 20. Therefore, as shown in FIG. 5A, even in a case of providing the screw hole of the fastening screw 10 to be perpendicular to the mounting seat face 103 of the tool body 100, and as shown in FIG. 5B, even in a case of providing the screw hole of the fastening screw 10 to inclined to the mounting seat face 103 of the tool body 100, the cutting insert 20 can mounted to the tool body 100 by stable contact therebetween. As shown in FIG. 5B, since the configuration, in which the screw hole of the fastening screw 10 is provided to be inclined to the mounting seat face 103 of the tool body 100, effectively produces the force for the clamp auxiliary member 1 to press the cutting insert 20 closer to the wall 102, the configuration is effective as means for pressing the aforementioned cutting insert 20 to the mounting seat face 102 of the tool body 100.

In this manner, the cutting insert is mounted to the tool body through the clamp auxiliary member which is provided with the engagement portion with the fastening screw, is formed in a ring-shape a part of which is completely notched, and is flexibly deformed at the time the force is applied to the inner peripheral face upper portion thereof from the head portion of the fastening screw to expand the outer diameter. This configuration makes it possible to realize the clamp auxiliary member which is low in manufacturing costs in a simple structure, applicable to a small-diameter tool, and excellent in operability at replacement of the cutting insert, and the cutting tool provided with the clamp auxiliary member.

### Second Embodiment

Hereinafter, a second embodiment in the present invention will be explained with reference to the drawings. Since the basic configuration in the present embodiment is similar to that in the first embodiment, hereinafter only the characteristic differences of the configuration will be explained.

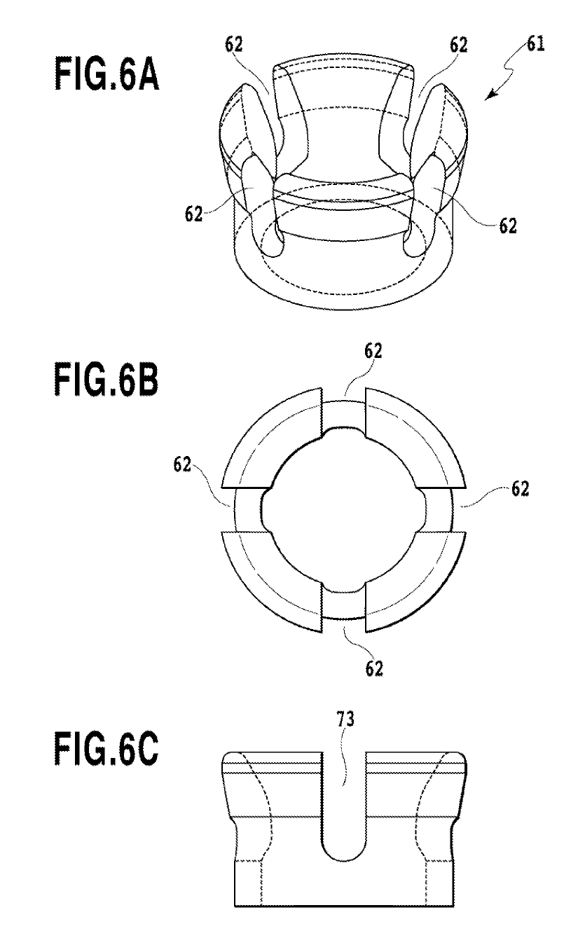

FIG. 6A to FIG. 6C are diagrams each showing a clamp auxiliary member 61 according to the present embodiment, wherein FIG. 6A is a perspective view, FIG. 6B is a plan view, and FIG. 6C is a side view. The clamp auxiliary member 61 according to the present embodiment is formed in a ring shape, but is not provided with the through slit portion 6 (refer to FIG. 1B) formed by completely notching a part of the clamp auxiliary member as shown in the first embodiment. Instead, the clamp auxiliary member 61 is provided with four upper partial slit portions 62 circumferentially spaced apart from one another in positions respectively shifted by about 90 degrees, each upper partial slit portion 62 being formed by notching the clamp auxiliary member from the upper portion thereof to a substantially central portion thereof in the height direction as shown in FIG. 6A. Even though the upper partial slit portions 62 are not formed by completely notching the upper portion of the clamp auxiliary member 61 in the present embodiment, the elastic deformation of the clamp auxiliary member 61 can still be obtained at the time of tightening the fastening screw 10 and the cutting insert 20 can be fixed to the tool body 100.

It should be noted that the number of the partial slit portions is not limited to four. However, having one or more upper partial slit portions 62 formed by notching the clamp auxiliary member from the upper portion to the substantially central portion are required the present embodiment.

In this manner, the cutting insert is mounted to the tool body be means of the clamp auxiliary member 61 which is formed in a ring shape, is provided with an engagement portion for engaging the fastening screw, is provided with one or more circumferentially spaced apart upper partial slit portions 62 formed by notching the clamp auxiliary member from the upper portion to the substantially central portion in the height direction, and is flexibly deformed at the time force is applied to the inner peripheral face upper portion thereof from the head portion of the fastening screw to expand the outer diameter. This configuration makes it possible to realize the clamp auxiliary member which is low in manufacturing costs in a simple structure, applicable to a small-diameter tool, and excellent in operability at replacement of the cutting insert 20, and the cutting tool provided with the clamp auxiliary member.

### Third Embodiment

Hereinafter, a third embodiment in the present invention will be explained with reference to the drawings. Since the basic configuration in the present embodiment is similar to that in the first embodiment, hereinafter only the characteristic differences in the configuration will be explained.

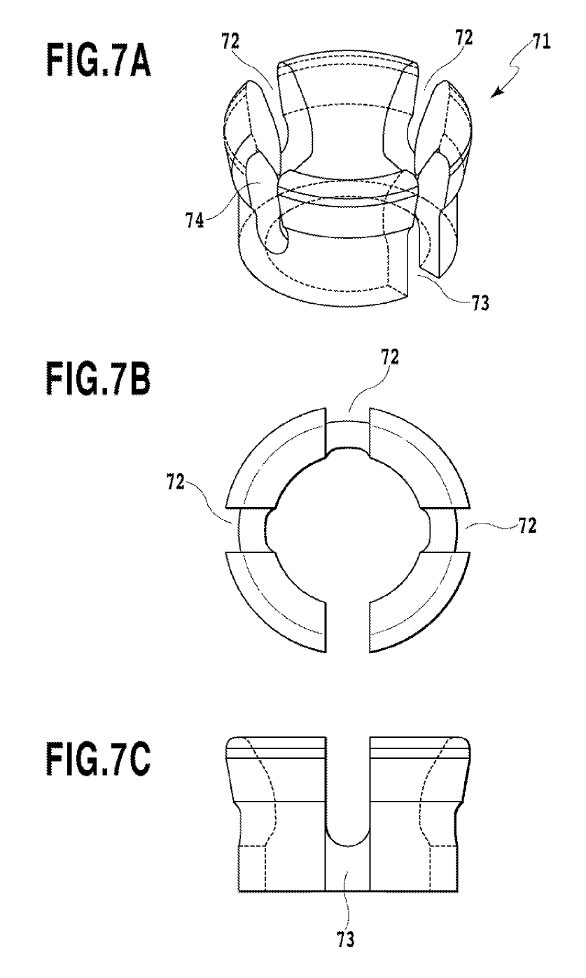

FIG. 7A to FIG. 7C are diagrams each showing a clamp auxiliary member 71 according to the present embodiment, wherein FIG. 7A is a perspective view, FIG. 7B is a plan view, and FIG. 7C is a side view. The clamp auxiliary member 71 according to the present embodiment includes features found in both the first embodiment and the second embodiment. More particularly, clamp auxiliary member 71 is provided with a through slit portion 73 formed by completely notching a part of the clamp auxiliary member 71 and a plurality of upper partial slit portions 72 formed by notching the clamp auxiliary member from an upper portion thereof to a substantially central portion thereof in the height direction. Even in the configuration of the clamp auxiliary member 71 in the present embodiment, the elastic deformation of the clamp auxiliary member 71 can be obtained at the time of tightening the fastening screw 10 and the cutting insert 20 can be fixed to the tool body 100.

It should be noted that the number of the upper partial slit portions 72 formed by notching the clamp auxiliary member 71 from the upper portion to the substantially central portion in the height direction is not limited to three. It is only required to provide one or more upper partial slit portions 72 formed by notching the clamp auxiliary member from the upper portion to the substantially central portion as the present embodiment and the slit portion 73 formed by completely notching the part of the clamp auxiliary member.

In this manner, the cutting insert 20 is mounted to the tool body 100 by means of the clamp auxiliary member 71 which is provided with an engagement portion for engaging the fastening screw, is formed in a ring shape completely notching the part of the clamp auxiliary member, is provided with one or more circumferentially spaced apart upper partial slit portions 72 formed by notching the clamp auxiliary member from the upper portion to the substantially central portion in the height direction, and is flexibly deformed at the time the force is applied to the inner peripheral face upper portion thereof from the head portion of the fastening screw to expand the outer diameter. This configuration makes it possible to realize the clamp auxiliary member which is low in manufacturing costs in a simple structure, applicable to a small-diameter tool, and excellent in operability at replacement of the cutting insert, and the cutting tool provided with the clamp auxiliary member.

### Fourth Embodiment

Hereinafter, a fourth embodiment in the present invention will be explained with reference to the drawings. Since the basic configuration in the present embodiment is similar to that in the first embodiment, hereinafter only the characteristic configuration will be explained.

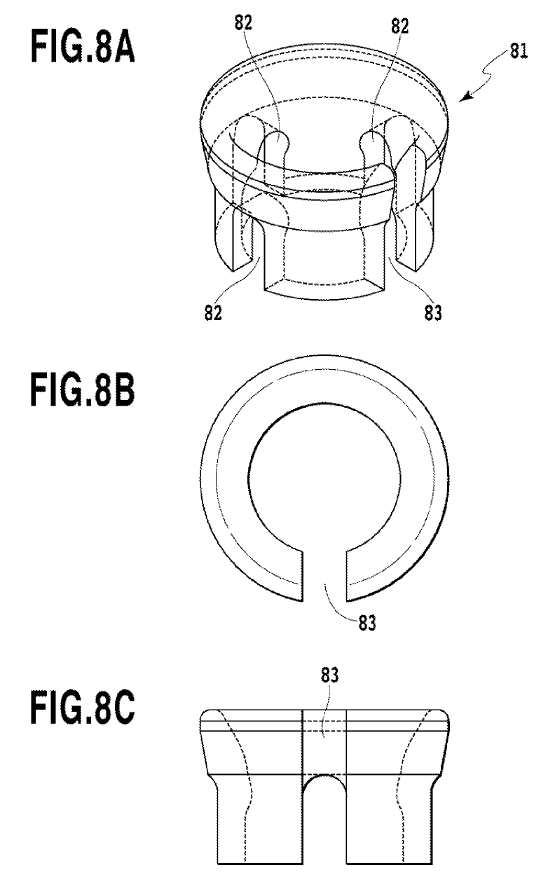

FIG. 8A to FIG. 8C are diagrams each showing a clamp auxiliary member 81 according to the present embodiment, wherein FIG. 8A is a perspective view, FIG. 8B is a plan view, and FIG. 8C is a side view. The clamp auxiliary member 81 according to the present embodiment is similar to the configuration in the third embodiment, but differs in a point of being provided with a plurality of lower partial slit portions 82 formed by notching the clamp auxiliary member from a lower portion thereof to a substantially central portion thereof in the height direction. A point where a slit portion 83 formed by completely notching a part of the clamp auxiliary member 81 is provided is the same as in the third embodiment. Even in the configuration of the clamp auxiliary member 81 in the present embodiment, the elastic deformation of the clamp auxiliary member 81 can be obtained at the time of tightening the fastening screw 10 and the cutting insert 20 can be fixed to the tool body 100.

It should be noted that the number of the lower partial slit portions 82 formed by notching the clamp auxiliary member from the lower portion to the substantially central portion in the height direction is not limited to three. It is only required to provide one or more lower partial slit portions 82 formed by notching the clamp auxiliary member from the lower portion thereof to the substantially central portion thereof as the present embodiment and the through slit portion 83 formed by completely notching the part of the clamp auxiliary member.

In this manner, the cutting insert is mounted to the tool body by means of the clamp auxiliary member 81 which is provided with an engagement portion for engaging the fastening screw, is formed in a ring shape completely notching the part of the clamp auxiliary member, is provided with one or more partial lower slit portions formed by notching the clamp auxiliary member from the lower portion thereof to the substantially central portion thereof in the height direction, and is flexibly deformed at the time the force is applied to the inner peripheral face upper portion thereof from the head portion of the fastening screw to expand the outer diameter. This configuration makes it possible to realize the clamp auxiliary member which is low in manufacturing costs in a simple structure, applicable to a small-diameter tool, and excellent in operability at replacement of the cutting insert, and the cutting tool provided with the clamp auxiliary member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

1 Clamp auxiliary member
2 Inclined inner face
3 Inclined outer face
6 Through slit portion
7 Main body
10 Fastening screw
13 Head portion
16 Fitting section
20 Cutting insert
21 Inclined face
31 Fitting section
61 Clamp auxiliary member
62 Upper partial slit portion
71 Clamp auxiliary member
72 Upper partial slit portion
73 Through slit portion
81 Clamp auxiliary member
82 Lower partial slit portion
83 Through slit portion
91 Top surface
92 Bottom Surface
95 Upper portion
96 Lower portion
97 Central portion
100 Tool body
101 Mounting seat
102 Wall face of a mounting seat
103 Mounting seat face
105 Counter bore
D5 Minimum dimension
S1 Inner peripheral face
S2 Inner peripheral face upper portion
S3 Outer peripheral face upper portion

What is claimed is:

1. An elastically deformable clamp auxiliary member including a ring-shaped main body which, when a cutting insert provided with a mounting hole formed therein is clamped to a mounting seat in a tool body by a bolt inserted into the mounting hole, expands in a diameter between the cutting insert and the bolt to press the cutting insert from an inside thereof, thereby assisting the clamping of the cutting insert by the bolt, the clamp auxiliary member comprising:
a first engagement portion engaged to a large-diameter portion formed in the bolt and expanding the main body in a diameter by a relative movement to the bolt;
a second engagement portion capable of being engaged to a retaining portion provided in the bolt; and
a third engagement portion applying a pressing force to an inner peripheral wall of the mounting hole, wherein
when the bolt is threaded into a screw hole provided in the mounting seat in a state where the second engagement portion is engaged to the retaining portion,
the clamp auxiliary member makes contact with the mounting seat, which restricts the movement to cause a relative movement thereof to the bolt,
the first engagement portion is subjected to a force from the large-diameter portion to be expanded in a diameter,
the engagement of the second engagement portion is released simultaneously with the diameter expanding of the first engagement portion,
the third engagement portion presses the inner peripheral wall of the mounting hole to clamp the cutting insert to the mounting seat, and
when the bolt threaded into the screw hole is loosened, the second engagement portion is returned back to the retaining portion by the recovery force.

2. The elastically deformable clamp auxiliary member defined in claim 1, wherein
the third engagement portion is formed to be capable of allowing at least one of eccentricity between a center axis line of the cutting insert and a center axis line of the screw hole in the mounting seat, and an inclination of the center axis line of the screw hole to a center axis line of the mounting hole in the cutting insert fixed to the mounting seat.

3. The elastically deformable clamp auxiliary member defined in claim 2, wherein
the third engagement portion is formed as a curved surface, curved in a convex shape to the inner peripheral wall of the mounting hole in the cutting insert.

4. A cutting tool comprising:
a cutting insert provided with a mounting hole;
a tool body provided with a mounting seat;
a bolt inserted into the mounting hole of the cutting insert for clamping the cutting insert to the mounting seat of the tool body; and
an elastically deformable clamp auxiliary member provided with a ring-shaped main body which is, when the cutting insert is clamped to the mounting seat in the tool body by the bolt, interposed between the cutting insert and the bolt to flexibly expand in a diameter therebetween to assist the clamping of the cutting insert by the bolt, wherein
the bolt comprises:
a retaining portion for retaining the clamp auxiliary member in a state where the clamp auxiliary member is not expanded in a diameter; and a large-diameter portion for expanding the clamp auxiliary member in a diameter, and
the clamp auxiliary member comprises:
a first engagement portion engaged to the large-diameter portion formed in the bolt and expanding the main body in a diameter by a relative movement to the bolt;
a second engagement portion capable of being engaged to the retaining portion in the bolt; and
a third engagement portion capable of making contact with an inner peripheral wall of the mounting hole in the cutting insert at the time of being expanded in a diameter by the large-diameter portion, wherein
when the bolt is tightened,
the clamp auxiliary member moves together with the bolt in a state where the second engagement portion is engaged to the retaining portion,
the clamp auxiliary member makes contact with the mounting seat, which restricts the movement to cause a relative movement thereof to the bolt, thereby the engagement of the second engagement portion is released and the first engagement portion is subjected to a force from the large-diameter portion to be expanded in a diameter to clamp the cutting insert to the mounting seat, and
when the bolt tightened into the mounting hole in the cutting insert is loosened, the second engagement portion is returned back to the retaining portion by the recovery force.

5. An elastically deformable clamp auxiliary member configured to receive a bolt suitable for clamping a cutting insert in a cutting tool, comprising:
a ring-shaped main body having central member axis (A) and extending in an axial direction between a top surface and a bottom surface, the main body having an upper portion proximate the top surface, a lower portion proximate the bottom surface and a central portion in-between, the upper portion having an outer diameter that decreases in a direction of the bottom surface and is larger than the lower portion's outer diameter;
a first engagement portion formed on an inner peripheral face upper portion of the main body, the first engagement portion having an inclined inner face;
a second engagement portion formed on an inner peripheral face of the main body where the inner peripheral face has a minimum dimension, the second engagement portion being located axially below the first engagement portion in a direction from the top surface to the bottom surface;
a third engagement portion formed on an outer peripheral face upper portion of the main body; and
at least one axially extending slit passing between the inner peripheral face upper portion and the outer peripheral face upper portion, from the top surface to at least the central portion, wherein:
the upper portion is configured to expand in a radially outward direction, in response to a force which is applied along the central member axis (A) in the direction of the bottom surface and impacts the inner peripheral face upper portion.

6. The elastically deformable clamp auxiliary member defined in claim 5, wherein the at least one axially extending slit comprises:
a single through slit which extends along the entire length of the main body from the top surface to the bottom surface.

7. The elastically deformable clamp auxiliary member defined in claim 5, wherein the at least one axially extending slit comprises:
a plurality of upper partial slits circumferentially spaced apart from one another and extending from the top surface to the central portion of the main body, but not intersecting the bottom surface, and wherein
no through slit extends along the entire length of the main body from the top surface to the bottom surface.

8. The elastically deformable clamp auxiliary member defined in claim 5, wherein the at least one axially extending slit comprises:
a plurality of upper partial slits circumferentially spaced apart from one another and extending from the top surface to the central portion of the main body, but not intersecting the bottom surface, and
a through slit extending along the entire length of the main body from the top surface to the bottom surface.

9. The elastically deformable clamp auxiliary member defined in claim 5, wherein the at least one axially extending slit comprises:
a plurality of lower partial slits circumferentially spaced apart from one another and extending from the bottom surface to the central portion of the main body, but not intersecting the top surface, and
a through slit extending along the entire length of the main body from the top surface to the bottom surface.

10. The elastically deformable clamp auxiliary member defined in claim 5, wherein the third engagement portion has an inclined outer face.

11. The elastically deformable clamp auxiliary member defined in claim 5, wherein the third engagement portion has a curved outer face.

12. A cutting tool assembly comprising:
a tool body provided with a mounting seat;
a cutting insert provided with a mounting hole;
a bolt insertable into the mounting hole of the cutting insert for clamping the cutting insert to the mounting seat of the tool body; and
the elastically deformable clamp auxiliary member in accordance with claim 5 configured to receive the bolt and be retained thereon, to thereby be interposed between the cutting insert and the bolt, when the bolt is inserted into the mounting hole of cutting insert

13. The cutting tool assembly defined in claim 12, wherein the bolt comprises:
a retaining portion for retaining the clamp auxiliary member in a state where the clamp auxiliary member is not expanded; and
a large-diameter portion configured to expand the clamp auxiliary member, when the bolt is inserted into the mounting hole of cutting insert and engaged to the mounting seat of the tool body and tightened.

14. The cutting tool assembly defined in claim 13, wherein:
the mounting hole of the cutting insert is sufficiently large to remove the cutting insert over the bolt's large-diameter portion, when bolt is not tightened but still engaged to the mounting seat of the tool body.

15. The cutting tool assembly defined in claim 13, wherein, when the bolt is inserted into the mounting hole of cutting insert and engaged to the mounting seat of the tool body and tightened:
the bolt's large-diameter portion engages the first engagement portion of the clamp auxiliary member and expands the upper portion of the main body, as the bolt travels relative to first engagement portion; and
expansion of the upper portion of the main body causes the third engagement portion to contact an inner peripheral wall of the cutting insert's mounting hole, to thereby clamp the cutting insert in the mounting seat of the tool body.
